(19) United States
(12) Patent Application Publication
(10) Pub. No.: US 2019/0114696 A1
(43) Pub. Date: Apr. 18, 2019

(54) APPARATUS, SYSTEM AND METHOD FOR ELECTRONIC INTERRELATING OF A HOME AND THE GOODS AND SERVICES WITHIN IT

(71) Applicant: HomDNA, Inc., Newport Beach, CA (US)

(72) Inventors: Chad Steelberg, Newport Beach, CA (US); Laura O'Donnell-Dunn, Hermosa Beach, CA (US); Daniel Akiva, Laguna Niguel, CA (US); Phyllis Fang, Laguna Beach, CA (US)

(21) Appl. No.: 15/954,381

(22) Filed: Apr. 16, 2018

Related U.S. Application Data
(63) Continuation of application No. 14/861,974, filed on Sep. 22, 2015, now abandoned.
(60) Provisional application No. 62/053,627, filed on Sep. 22, 2014.

(51) Int. Cl. G06Q 30/06; G06Q 50/16

(52) U.S. Cl. CPC G06Q 30/0641; G06Q 50/167

(57) ABSTRACT

The present invention provides a method for interrelating goods and services by collecting information related to at least one item within a structure associated with at least one owner of said at least one item, providing said information to at least one server communicatively coupled to at least one service provider accessible application, wherein said application is resident on a device having a tangible computing processor, the processor in data communication with a non-transitory computer memory that stores instructions which, when executed on the processor, provides to the at least one service provider a graphical user interface; and receiving through the at least one service provider accessible application an authorization to offer at least one service associated with the at least one item.

### CROSS REFERENCE TO RELATED APPLICATIONS

The present application is a continuation of U.S. patent application Ser. No. 14/861,974, filed Sep. 22, 2015, which claims priority to U.S. Provisional Patent Application Ser. No. 62/053,627, filed Sep. 22, 2014, the disclosures of which are hereby incorporated in their entireties.

### FIELD OF THE DISCLOSURE

The present disclosure relates to home living, and, more specifically, to an apparatus, system and method for electronic interrelating of a home and the goods and services within it.

### BACKGROUND

Processes for purchasing a home are well known. Populating a home with appliances, furnishings, and the like is also well known. However, the lack of a tie between the home and its appliances and furnishings, and the inability to tie any of the foregoing to the services provided to the home, is a significant gap in optimizing home ownership.

### BRIEF DESCRIPTION OF THE FIGURES

The present disclosure will become more fully understood from the detailed description given herein below and the accompanying drawings which are given by way of illustration only, and which thus do not limit the present disclosure.

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates an aspect of an exemplary embodiment of the present invention;

FIG. 5 illustrates an aspect of an exemplary embodiment of the present invention;

FIG. 6 illustrates an aspect of an exemplary embodiment of the present invention;

FIG. 7 illustrates an aspect of an exemplary embodiment of the present invention;

FIG. 8 illustrates an aspect of an exemplary embodiment of the present invention;

FIG. 9 illustrates an aspect of an exemplary embodiment of the present invention;

FIG. 10 illustrates an aspect of an exemplary embodiment of the present invention;

FIG. 11 illustrates an aspect of an exemplary embodiment of the present invention;

FIG. 12 illustrates an aspect of an exemplary embodiment of the present invention;

FIG. 13 illustrates an aspect of an exemplary embodiment of the present invention;

FIG. 14 illustrates an aspect of an exemplary embodiment of the present invention;

FIG. 15 illustrates an aspect of an exemplary embodiment of the present invention;

FIG. 16 illustrates an aspect of an exemplary embodiment of the present invention;

FIG. 17 illustrates an aspect of an exemplary embodiment of the present invention; and

FIG. 18 illustrates an aspect of an exemplary embodiment of the present invention.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

All information associated with a home may be tracked, such as by a relational database, in accordance with the instant invention. That is, not only may the makes, models, colors, types, user manuals, updates, recalls, and the like be associated with all portions of a home and appliances, goods, furniture, and the like within the home, but additionally all services, service providers, bills, bill tracking, utilities, consumption, and the like may be associated with a given home. For example, product SKUs may be entered, or bar codes/QR codes/packaging/RF ID/NFC scanned to enter product information.

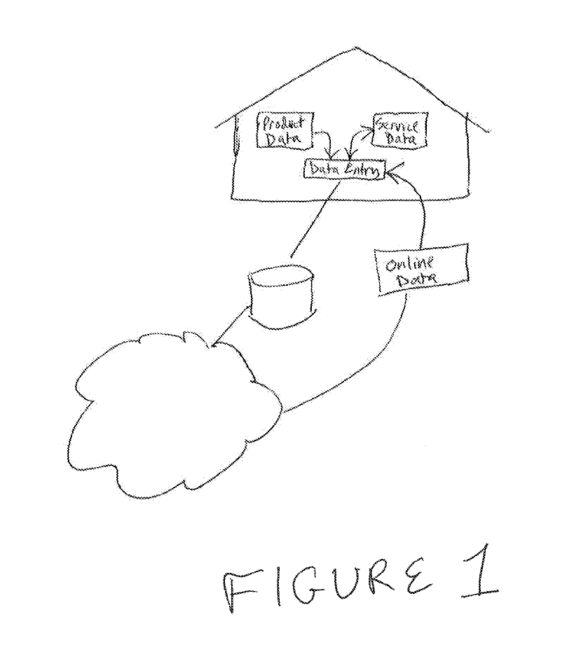

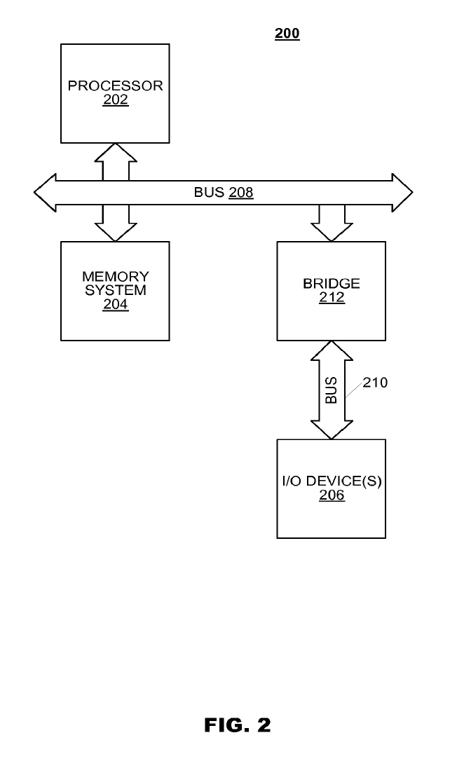

As illustrated in FIG. 1, a computer system may be employed to collect, analyze and access data associated with a home in accordance with the features and means related to the apparatus, systems and methods described herein. FIG. 2 is an example of a simplified functional block diagram of a computer system 200. The functional descriptions of the present invention can be implemented in hardware, software or some combination thereof. For example, a recommendation engine and an integration engine of the present invention can be implemented using a computer system.

As shown in FIG. 2, the computer system 200 includes a processor 202, a memory system 204 and one or more input/output (I/O) devices 206 in communication by a communication ‘fabric’. The communication fabric can be implemented in a variety of ways and may include one or more computer buses 208, 210 and/or bridge and/or router devices 212 as shown in FIG. 2. The I/O devices 206 can include network adapters and/or mass storage devices from which the computer system 200 can send and receive data for generating and transmitting advertisements with endorsements and associated news. The computer system 200 may be in communication with the Internet via the I/O devices 208.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

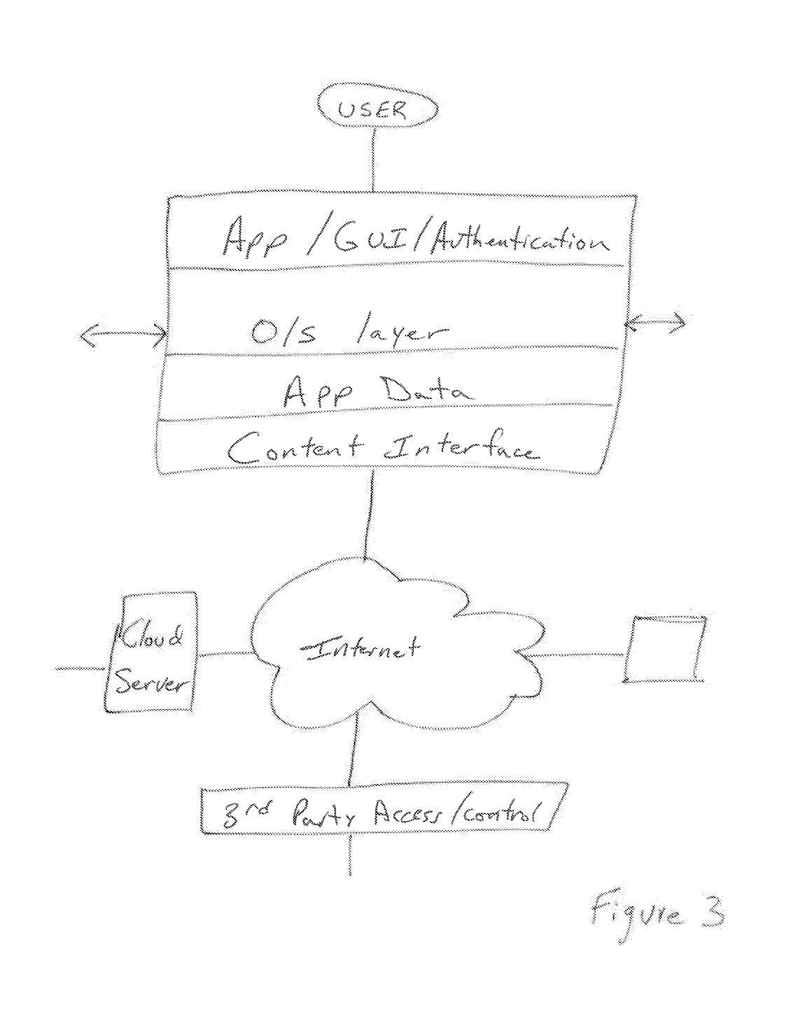

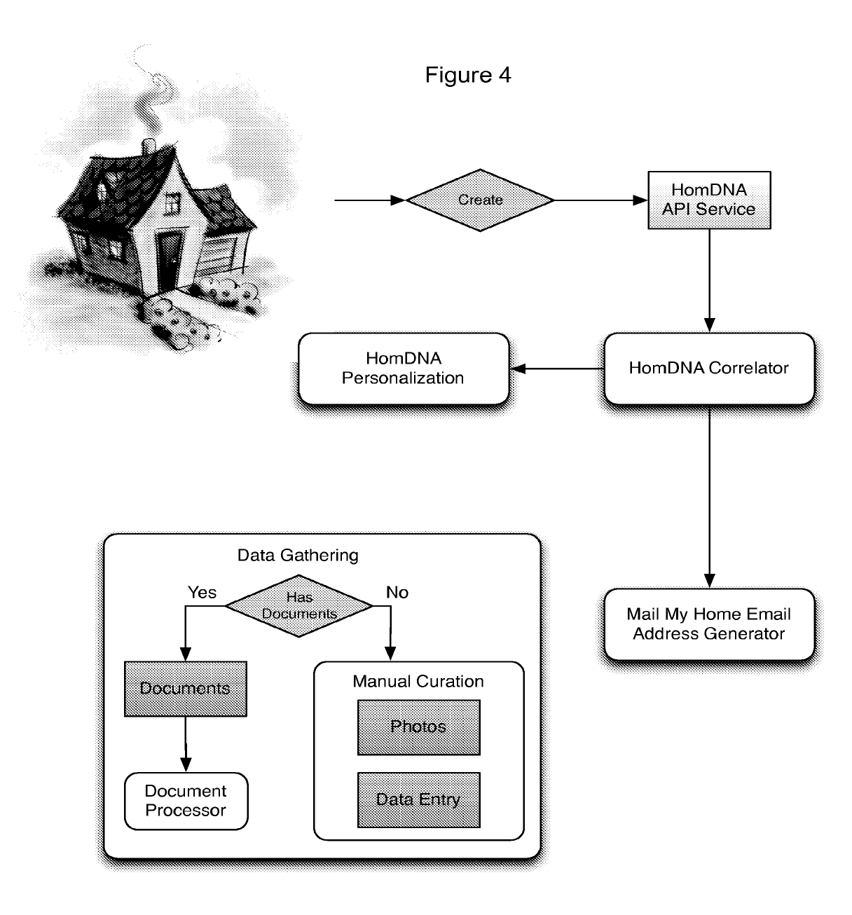

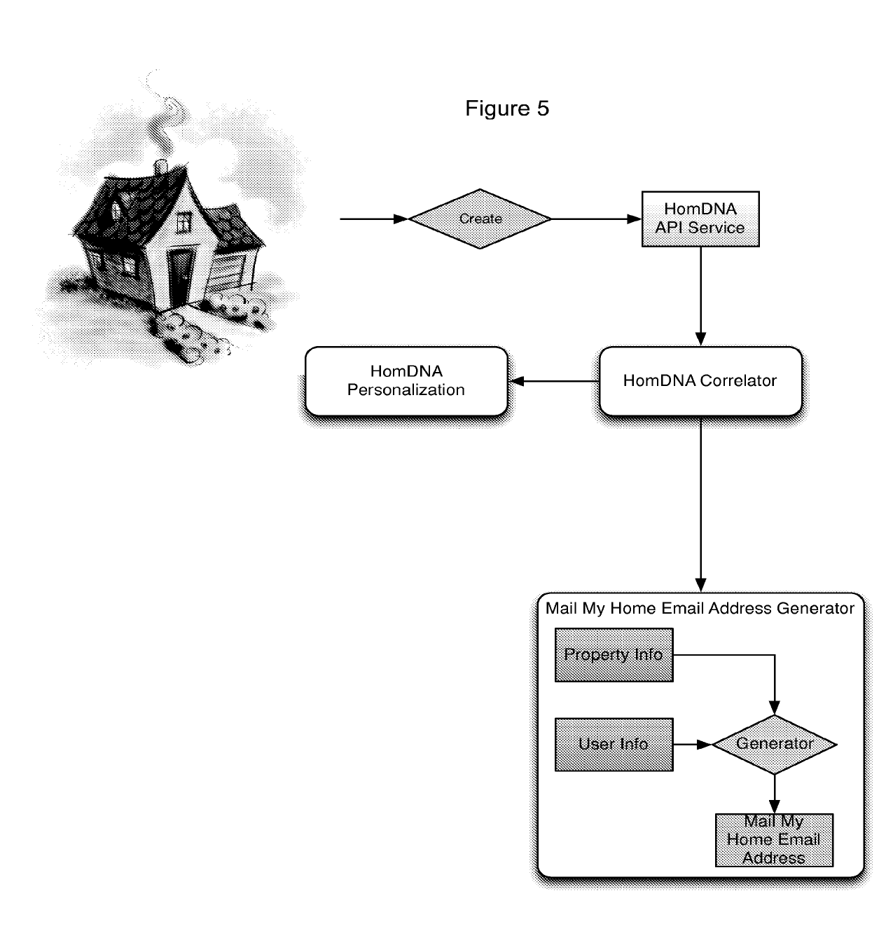

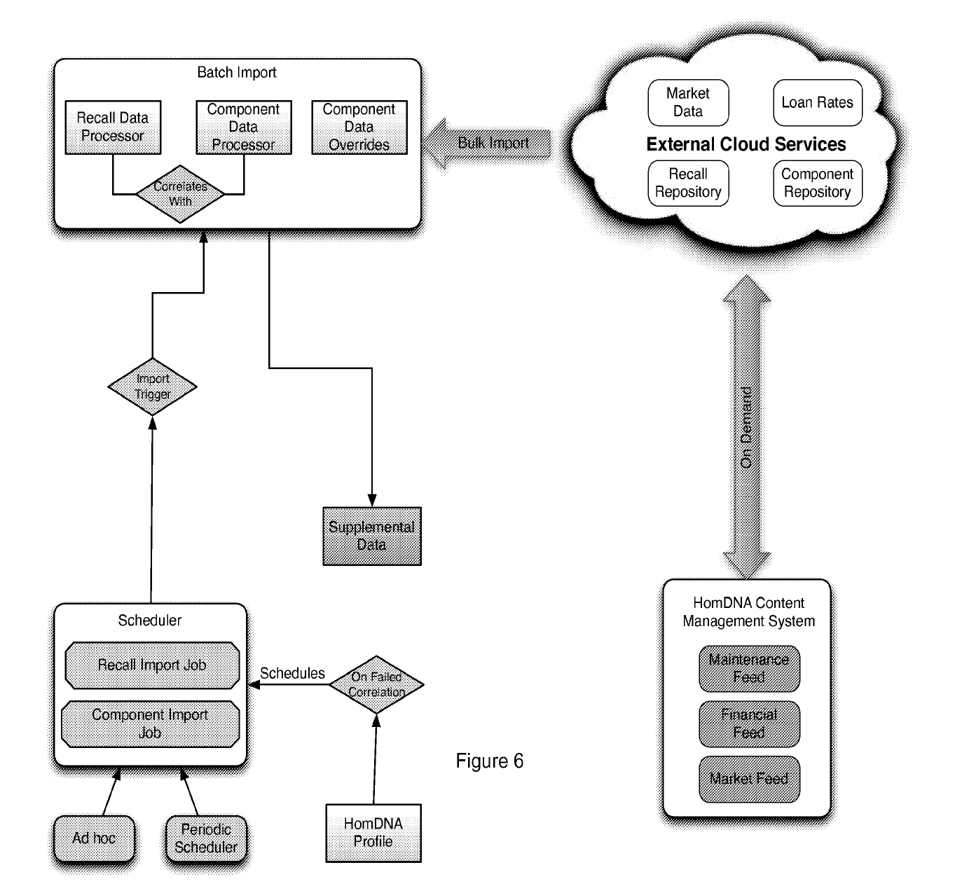

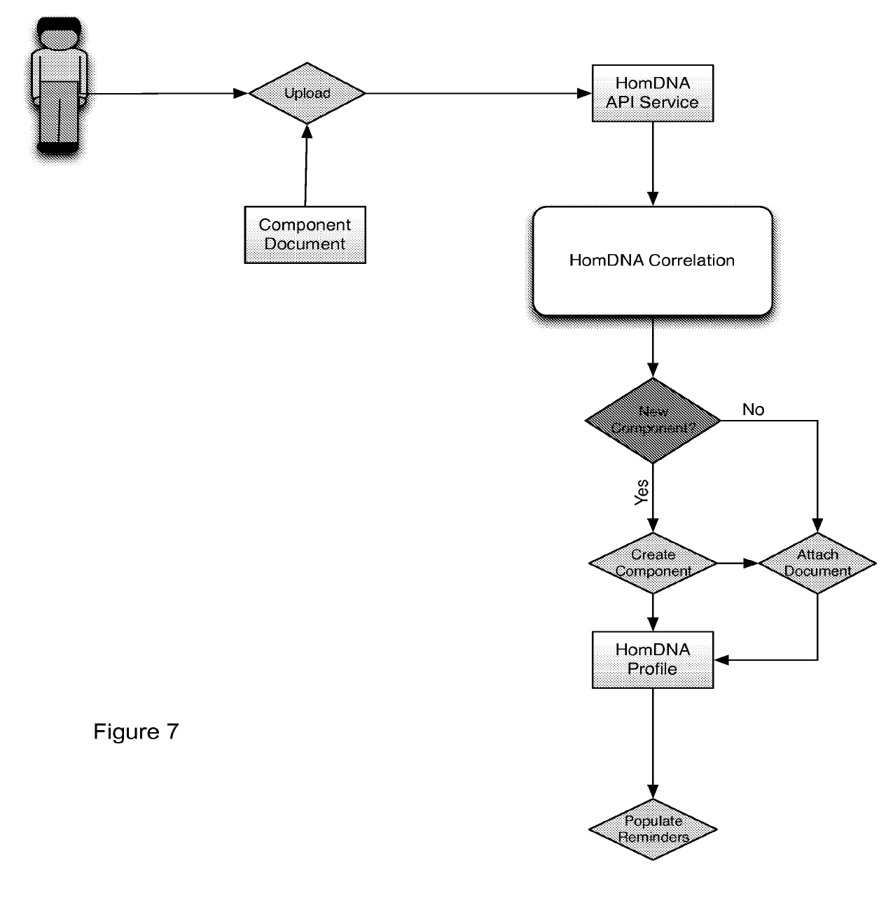

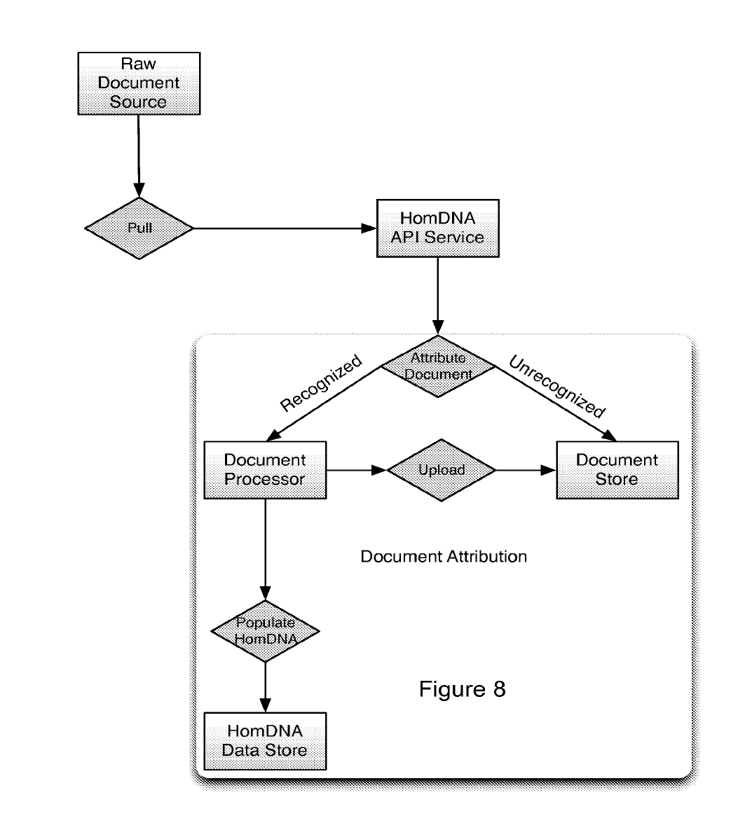

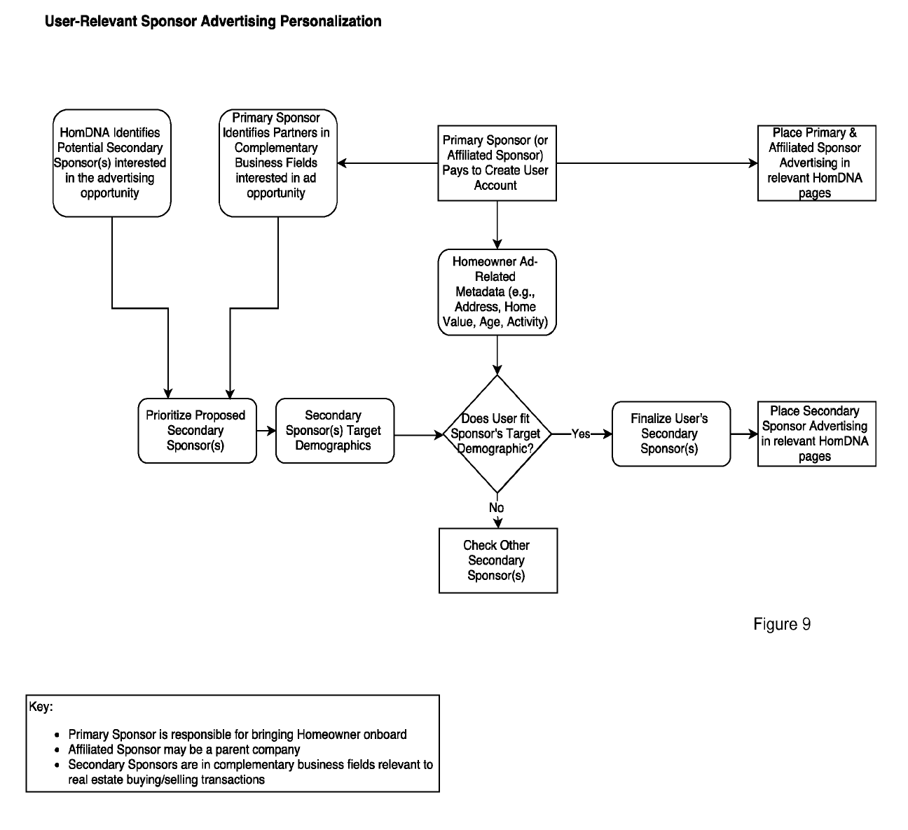

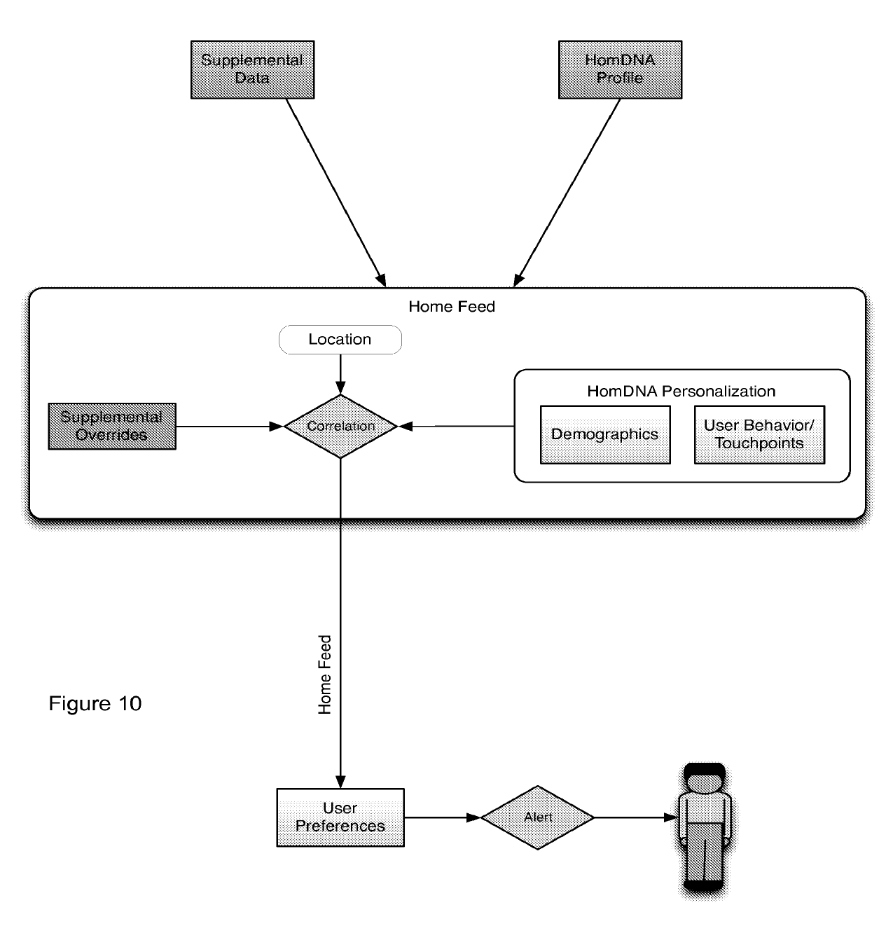

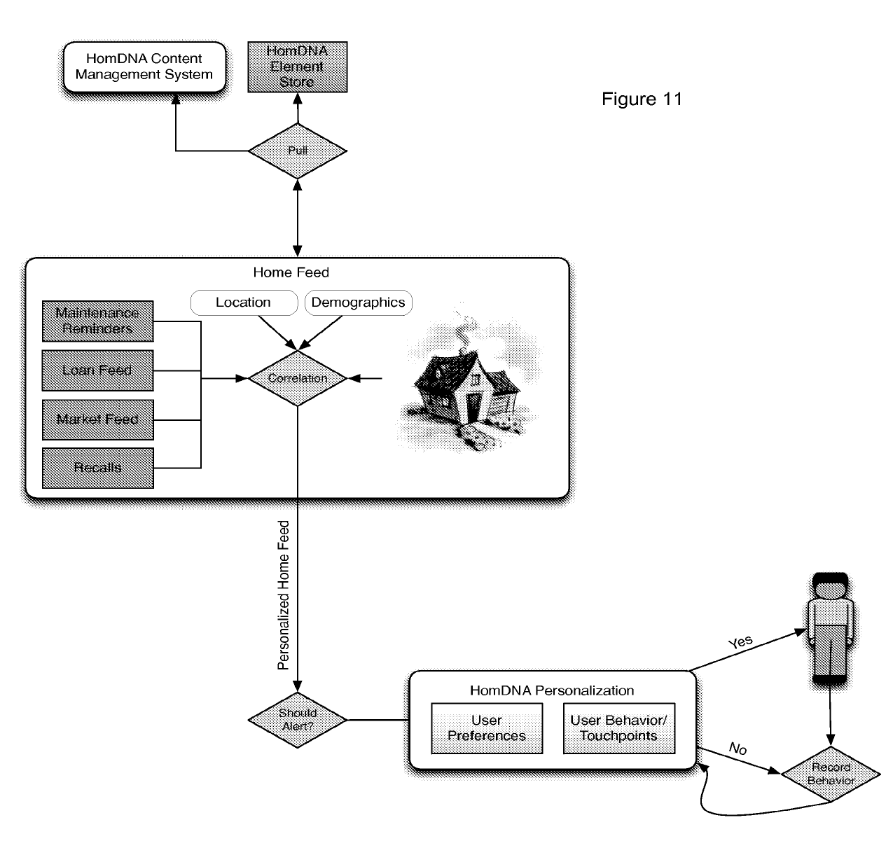

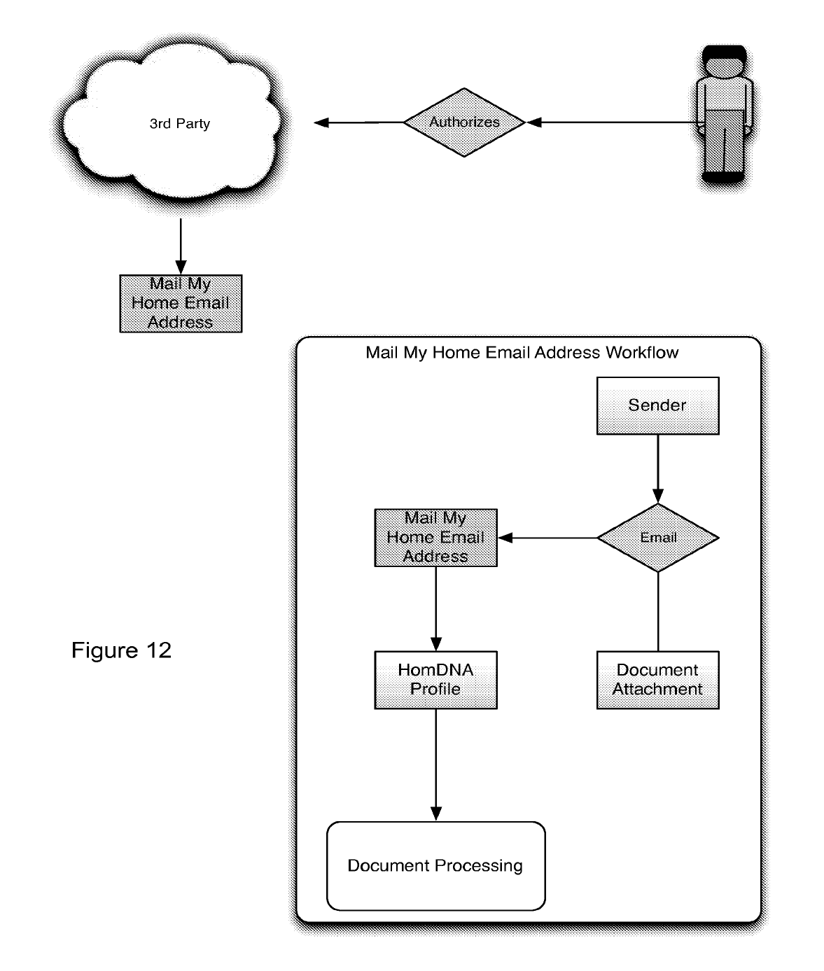

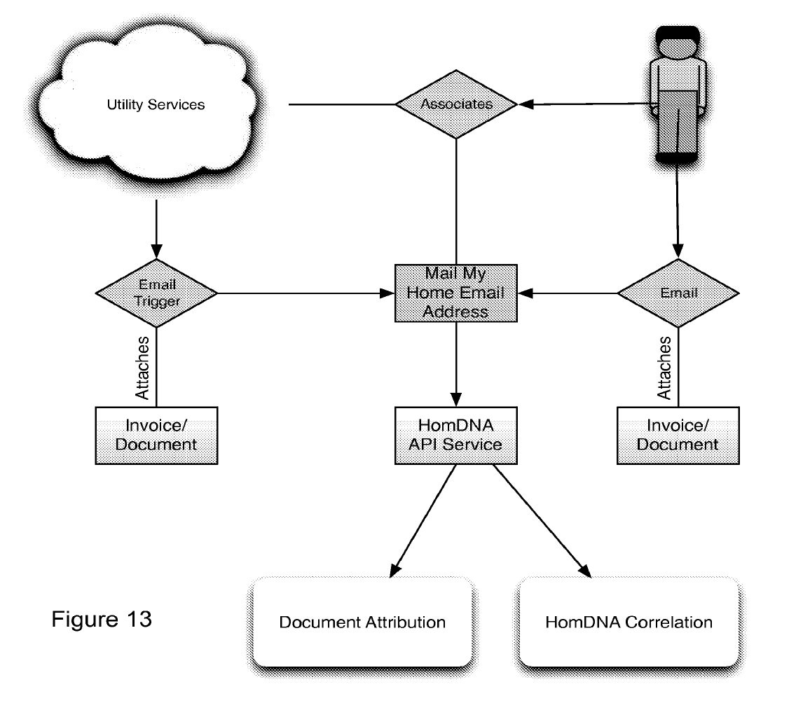

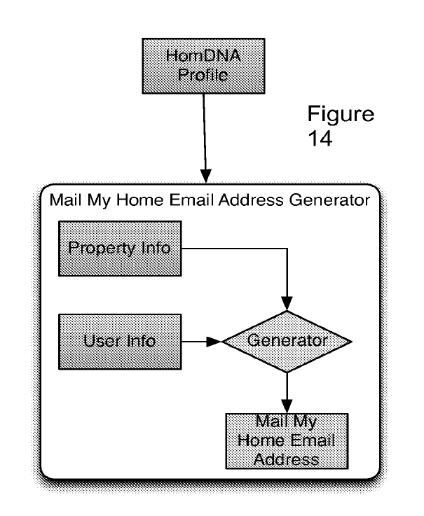

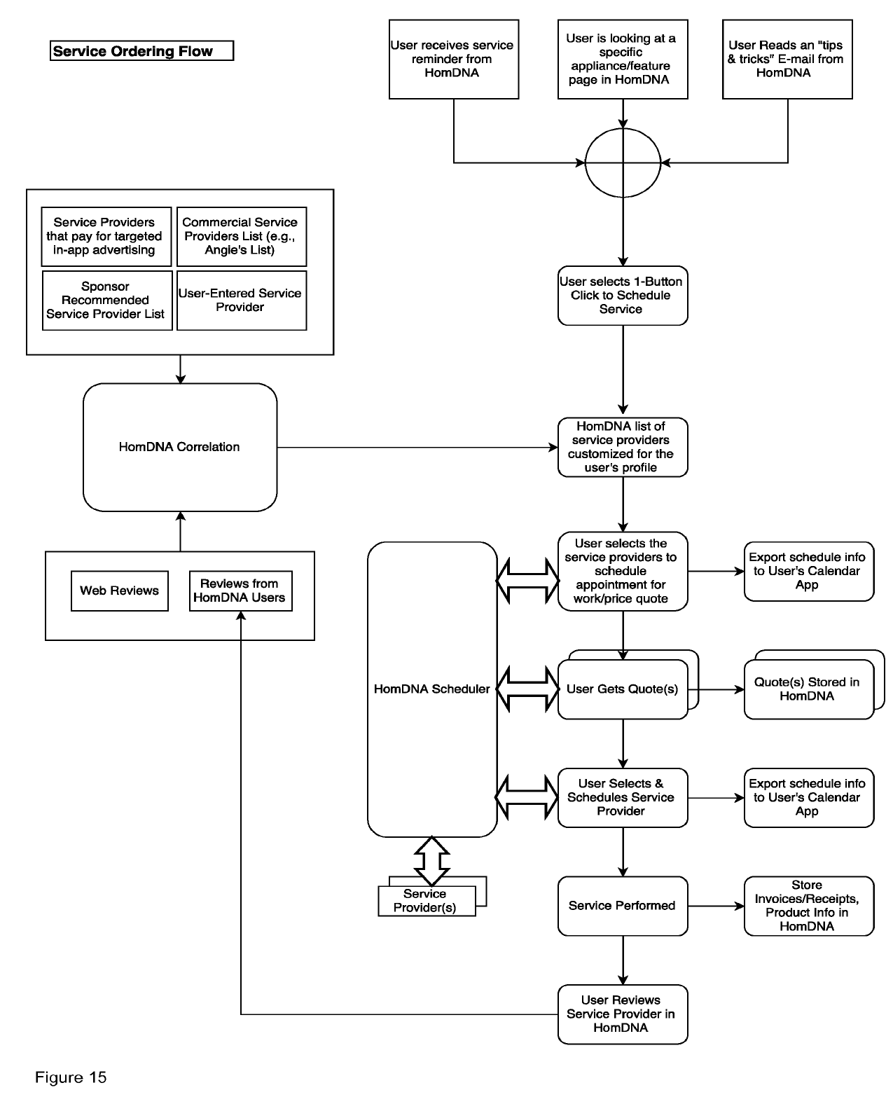

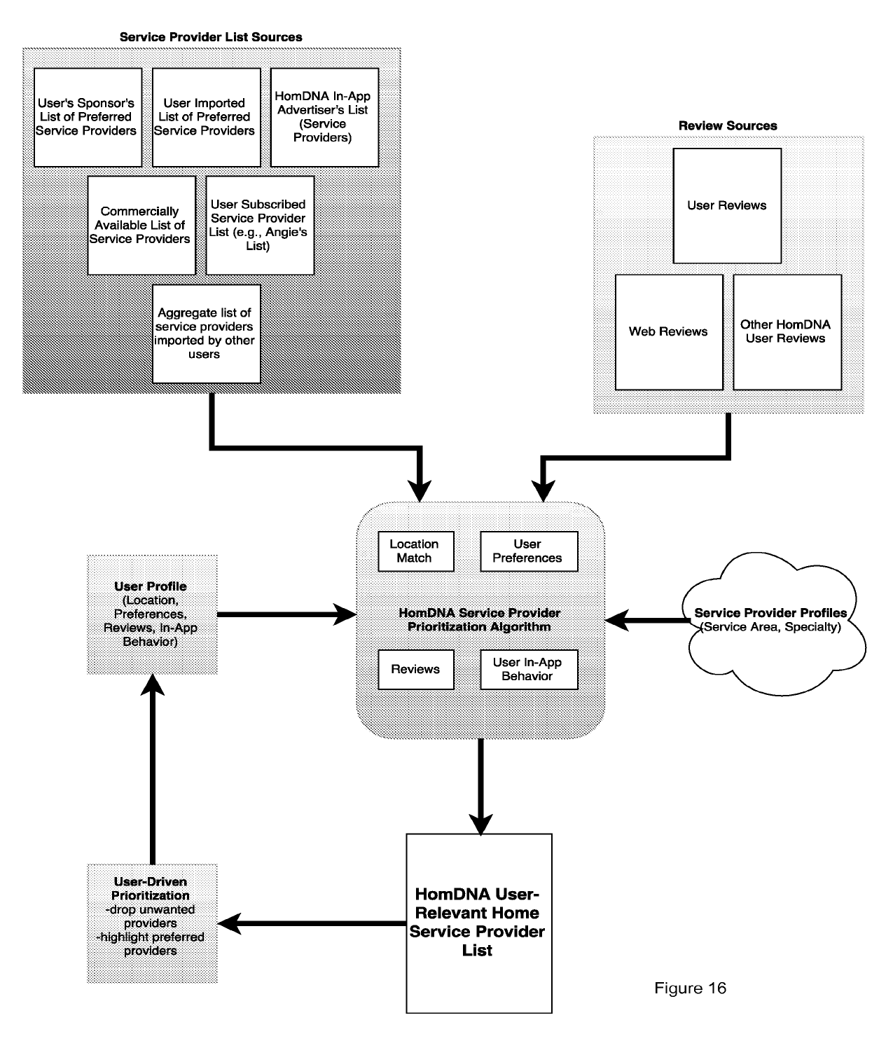

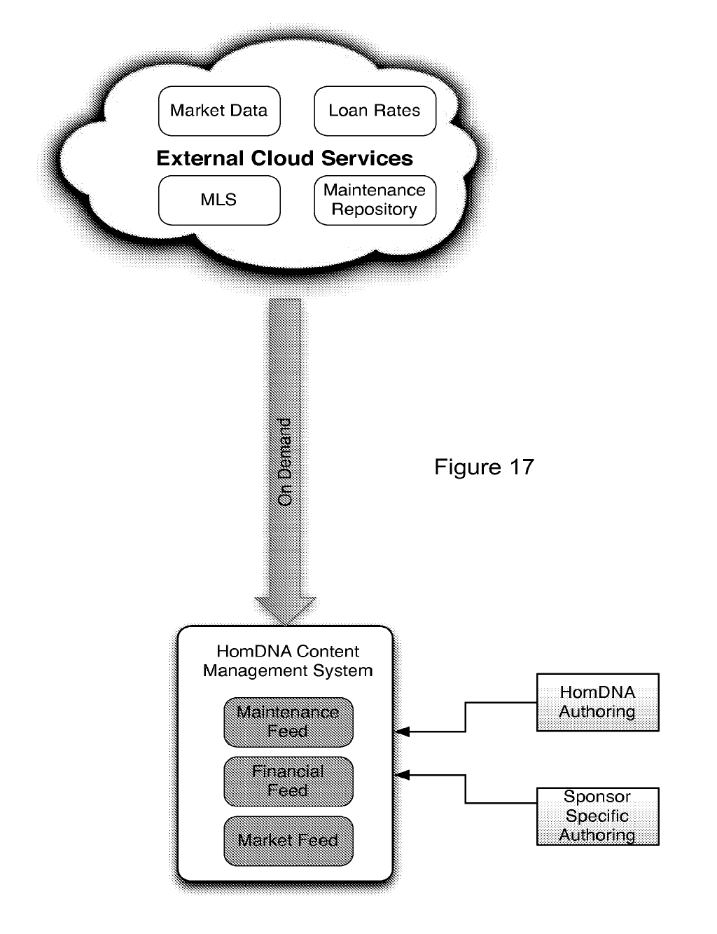

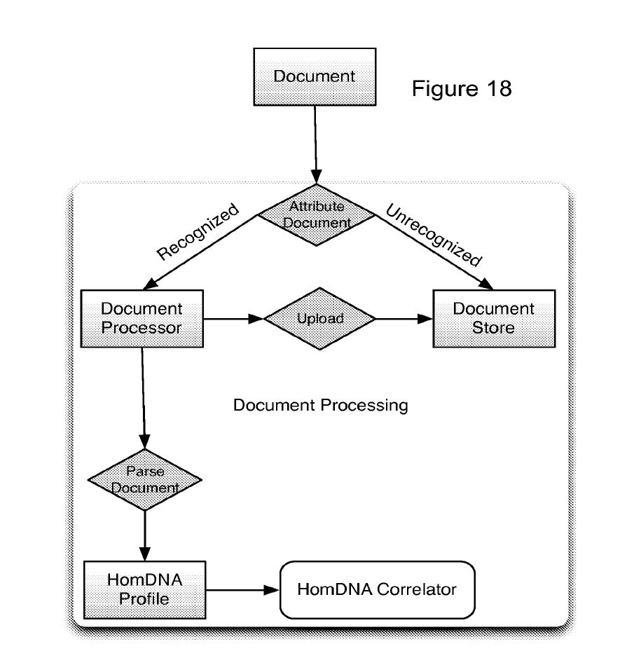

As shown in the embodiments illustrated in FIGS. 3-18, the present invention may allow at least one user access to the features and functionality detailed herein.

In an embodiment of the present invention, information associated with a home may include details specific to that home as well as supplemental information that is generally available but only as applicable to that specific home. Such a collection of data may allow for the creation of a composite data set for the home.

Home specific data may include details and characteristics of the property, structures, permanent or semi-permanent features and all contents, whether permanent or transient. Further, such details may include, but are not limited to, geographic, landscaping, surveys, utility connections, blueprints, materials and finishes, furnishings, appliances, electronics, mechanical and electrical systems model numbers, and/or serial numbers, for example. Further, home characteristics may include the location on the property or in the home, quality or condition as well as historical, on-going or transactional information such as bills, consumption, maintenance, repairs, property taxes, ownership, liens, receipts, and the like, for example.

Home specific data can be gathered in many ways, including, but not limited to, self-reporting from consumers, observation of the home by a third party, documents and online resources, and data collection from connected home elements. Such information may also come in a variety of forms, including, but not limited to, data entry, scanning of bar codes/QR codes/packaging/RF ID/NFC, photos, videos (first person, 3D, 360 degree), audio recordings, paper documents, electronic documents, parsed data sets, and the like, for example. Although such information may be gathered in a traditional way, as will be appreciated by those skilled in the art, a search engine, which may be automated, may be employed to gather all electronically available information to provide for the auto populating of some, if not all, of the house information desired. Some of these forms may be disaggregated or parsed for interpretation, storage and combination with other data. Disaggregation may be manual or may be automated using techniques such as optical character recognition for brand, serial or model information, amounts, or image recognition based on element characteristics such as bezels, size, shapes, distinguishing marks, and the like, for example.

In an embodiment of the present invention, home specific data may be combined with supplemental information that is applicable to the property, home and its contents to develop and complete [model] of the home. Such supplemental information includes, but is not limited to, manuals, warranty terms, recalls, city or state regulations, utility rates and rebates, local weather, neighborhood information, maintenance schedules and care specifications, safety procedures, emergency, for example. Further, over time, home information, components and associated characteristics may change. The composite home information may evolve and adjust with changes and may do so in real time and/or commensurate with the speed of information collection. For example, changes may be captured in a variety of ways, including, but not limited to, data entry by consumers or other third parties, service records, receipts, updated photos. Updates may be manual or automatic.

Similarly, various online tools may make available to the instant invention data that may additionally be associated with a home, such as estimated value of the home, estimated value of goods within the home, information regarding people in the home and the like. Accordingly, various levels of the instant invention or versions, may be made available. For example, a consumer version may be made available that includes additional data of interest to a home owner, such as estimated home value. On the other hand, a service provider version may be available that includes only the type of goods that can be repaired by that service provider within each home.

Additionally, consumers may purchase the instant invention for association with their home, or may receive the instant invention as a gift. For example, a realtor may provide the instant invention as a gift when consumers purchase a home using that realtor. As such, the instant invention may be “white labeled” to allow for branding by different realtors. This allows for service providers, such as realtors, to remain in the consciousness of home owners throughout home ownership.

Further, various additional unique information may be provided to be used in conjunction with a particular home. For example, the instant invention may provide a unique email address or addresses that are then associated with all relevant receipts, manuals, and the like for a given home associated with the email address or addresses. Moreover, unique log-in information may be provided that may allow consumers to access the subject information via, for example, a dedicated smart phone App, or via a webpage. Such accessible functionality may allow for interaction of parties, either over the web or in App, in transactions relevant to the home.

For example, if one year service is due on a new washing machine, a previously used repairman may be contacted with the homeowner in order to arrange a relevant time for a visit, and the service provider may indicate in the application when he is on the way to the home for the service appointment. In other instances, such as wherein a repairman is unknown to a homeowner, the repairman may be “verified”, such as with a picture, credentials, insurance, and the like, in order to provide the homeowner with additional peace of mind. Further, serviced providers may be rated by homeowners, such as with regard to reconstructions of kitchens, or the like, such that other homeowners may search for reviews of repairman, construction companies, service providers and the like. Moreover, ratings may also be linked to particular goods, rather than simply just services, which allows real-time review by many or all owners for particular goods, appliances, or the like.

As discussed above, the present invention may allow for the creation of a composite of information related to a property, whether a home, office, place of worship, or other structure and/or facility (such as a school and/or university, for example). Data gathering may be done by the homeowner, agent of the homeowner, the sponsor or the sponsor's agent, a professional curator, and/or a service professional visiting the home, for example. Data gathering may be done as a separate activity or may be included as part of or added to another service at the home, such as a home inspection, home appraisal, or a service call. Data gathering that is included as a part of or added on to another service, may be accomplished by expanding the standard scope of the data being gathered or may be all additional data. Multiple tools and/or resources may be used to gather the desired information and the data, once collected, may be kept separate and/or merged with the data from a single property, multiple properties held by the same person/entity, and/or with other related or unrelated third party/property data.

To simplify the processes which may be associated with data gathering, generic templates may be provided to a user through at least one GUI. Data gathering may be further simplified by pre-populating home characteristics available from online resources and documents. For example, utilize documents such as appraisals, MLS data, and the like, to create a skeleton of the home where the manual data gathering is limited to specific model and serial numbers. Further, for certain planned communities, available standard designs may be combed with public data (e.g., square footage, aerial photos, street photos), to, for example, estimate features and characteristics of a home, such as, for example, the floor plan and/or square footage of the home. Additionally, demographic data and general trends in the neighborhood may be utilized to build this skeleton. For example, homes greater than a certain value have a washer and dryer, or homes over a certain size have a dishwasher, or homes in a given neighborhood may have an attached garage and also have a garage door opener.

To augment gathered data, a 2-d or 3-d model of the home may be created and the data gathering may be via a guided walk through of the home. Similarly, location can be identified by tapping on the blueprint. Data which may be captured and/or used by the present invention may include, for example: structure, lot dimensions, exterior attributes; interior attributes, such as room photos, appliance photos, including model/serial no. sticker, OCR of manuals and other documents to create searchable fields; appliance details and specifications; manufacturer information; product manuals & other available documents contact numbers; product warranty information; recall information; and energy consumption, energy ratings.

The present invention may also provide to each user/home of the system a unique system-generated email address to enable homeowner & other sources to upload documents to a homeowner's account, including product-specific information, invoices, receipts, utility bills, utility company notices, for example. Homeowner may use the email address for utility bills and emails, which will be saved and displayed within the app/GUI associated with the present invention. Usage information and payments, for example, may be tracked from month to month to show usage trends, and analyzed for home-specific savings tips.

Home specific data may also extend beyond the physical aspects of the structure and its contents to include occupant demographics and behaviors. A comprehensive [DNA map] of a home may created by (1) combining the home specific data may with more general data applicable to that home and (2) interpreting the intersection of the specific data to infer preferences and personalize information, reminders, and maintenance schedules according to these preferences. Interpretation of information includes, but is not limited to, automated or manual image recognition of photos or videos, audio transcription, monitoring behavior, inferring demographic and psychographic information.

The present invention may provide spatial-cognitive organization of the data collected. For example, data collected in one portion of the experience (e.g., at the appliance level) and re-distributed or aggregated in other places (e.g., at the room, home, property, service provider level) to enable intuitive navigation. Further, as discussed herein, inspectors and/or service persons may be recommended and/or assigned to at least one of a plurality of properties. The assigning of a company and/or individual may be based on location, availability, cost, experience, other inspectors nearby.

The present invention may also allow for the managing of service providers which may be, for example, aggregated from other sources, such as, for example, the Yellow pages, HomeAdvisor, and Angie's List—including the ratings and key info. As will be appreciated by those skilled in the art, the present invention may also be provided a list of service providers from the homeowner, the homeowner's sponsor, and other users of the invention. The information may, for example, be pulled from a user's address book. Similarly, at least one of a plurality of providers may have a direct or otherwise substantially direct link with a single provider—passing service request directly to that provider. Additionally, a user (or sponsor) can identify a preferred provider or rank order providers and/or block a given provider. The present invention may also allow for the details of the service, include photo, description, and preferred time, of the service provider to be proffered prior to acceptance of the service call, for example.

The present invention may also allow for the arranging of services which may be coincident with the parsing of warranties—CC warranties, aftermarket warranties, tracking whether warranties are still valid, who to call for service if still in warranty versus out of warranty. Such a feature may be automated relative to scheduling of the service provider based on the location, type of service, user's preferences, price ranges, and/or service providers history/ratings. The present invention may also utilize other user's experience, preferences and blocking of providers to affect assignment of service providers, for example. Similarly, service requests, actual service that was performed, the cost of the service, any additional warranties, the type of service (capital or expense), and service schedule, who performed the service, may also be factors in preforming and/or offering a service provider. Connect this information with the to-do list, the preferred service provider network, financial center, and the home docs. This may be uploaded by HO, Service provider or HOMDNA, through portal, email, etc.

A qualified product, maintenance and service recommendation may be based on user's actual inventory and learned user preferences (if any). The present invention may allow for a “one-touch” (button) to connect with listed service providers for repair. In the event of item replacement, for example, the present invention may provide a list of user-compatible replacement options based on physical dimension limitations within the home, energy savings, with fully-featured product information, specifications, and/or web-based product reviews. The present invention may also provide service reminders (with an opt-out option) for known appliance/home system maintenance—including deeplinks to the page that has the product in need of service For qualified product, maintenance and service recommendations based on user's actual inventory—a one-touch (button) to connect with listed service providers for repair may be provided. In the event of item replacement, a list of user-compatible replacement options based on physical dimension limitations within the home, energy savings, with fully-featured product information, specifications, web-based product reviews and the like may be provided. The present invention may also determine or have information related to the homeowner preference for payment/service terms such as, for example, annually/semi-annually/monthly.

Thus, the present invention may add tasks to a “to-do” list using a one-touch (drop down menu of common fix/change actions) related to the home, specific rooms in the home, or appliances/features, Property Tax Reminders, One-Touch DIY info, Links to repair instructions, helpful tips, videos; Alerts—such as Recalls, weather, neighborhood info, and disaster info.

In an embodiment of the present invention, home energy consumption data via GreenButton Connect or other commercially available services may be available. For example, the present invention may capture appliance-specific energy usage (and other specific systems) from product information. Similarly, the present invention may provide an analysis of home-specific energy savings from old appliances to new appliances when considering appliance replacement and provide user-specific recommendations based on analysis of: energy usage based on home occupant demographics, energy consumption reporting via utility bills, GreenButton Connect, or other automated utility-tracking resources appliance energy consumption specifications.

“To-do” lists me be automatically created from inspection/appraisal lists, maintenance reminders, and manual entry, and may be at the appliance/room or top level and show up at all levels of the hierarchy. Such information may be grouped by service provider type so if a plumber is coming out you can take care of all pluming items.

Information may also be collected to allow users to collect ideas for replacing/upgrading any part of their home or any products. This can be in the form of photos, URLs, documents, text. These will be organized according to the item that is being replaced, upgraded or modified. These can also be aggregated at various levels, for example, ideas about the replacing the stove are captured with the stove, ideas about the refrigerator is captured at the refrigerator and they both can be seen in a single idea book at the kitchen. Alternatively, it can be added at the top level, and then parsed out to the sub-level.

In an embodiment of the present invention, a user may comparison shop for goods and/or services. For example, a user may wish to replace or purchase a specific type of product. User has selected multiple options or we identify options. We provide personalized comparison and or recommendation of the options based on any the following or any combination: location and typical usage in the area; measured usage of that type of product currently in the home; home's specific utility rates; actual usage by that family/home of the product; dimensions of current appliance in the home; dimensions of the space available for the new product; aggregated ratings; experience from other HomDNA users with the products being compared; suggested & recommended maintenance schedules and/or HO's preference regarding maintenance, for example.

The present invention may allow for the generation of annual budgets for home maintenance and help user allocate funds and track funds available for the maintenance. For the To Do list or Idea Book, set budgets and help user allocate funds and track funds available. Schedule work or prompt user to schedule when nearing or reach monetary goals. Similarly, third party payments may be directed to any good and/or service (including the use of coupons, credits, and/or promotional offers). In an embodiment of the present invention, users may cover the cost of items on the to do list/idea book. Include mechanism for collaborating and agreeing between the home occupant and the funder. Include approval of bids, materials etc. Send receipts to the home occupant and funder. May include access to a single account by the homeowner and the funder. Home occupant may be the homeowner or perhaps a renter or child of the owner. The funder may be the homeowner, perhaps a friend or family of the homeowner or occupant, or could also be the budgeting account referenced above.

The present invention may also allow for the requesting of quotes. Such quotes may include consideration of the volume of work on the to-do list/idea book, each individually or combined. Take action when there is a certain volume of work that makes a service call worthwhile, for example, assign each task type number of hours, type of service provider. When it hits a certain threshold for a given service provider, prompt the HO to get service or send out to service provider for bids or allow service provider to send targeted ad to homeowner with certain volume of items in certain area on the to do list.

The present invention may also provide a rewards system as would be understood by those skilled in the art. In addition, the present invention may allow for the tracking of maintenance records, such as one would do for a car. If the customer has a qualified service provider perform maintenance according to the schedule recommended by [insurance/builder/manufacturer], the HO gets a reward. If the customer does the maintenance themselves and uploads receipts/photos/etc., to show they have completed it, they get a reward.

What is claimed is:

1. A method for interrelating goods and services with a physical structure at a particular location, the method comprising:
collecting information related to at least one item within the structure and associated with at least one owner of said at least one item;
providing said information to at least one server communicatively coupled to at least one service provider accessible application, wherein said application is resident on a device having a tangible computing processor, the processor in data communication with a non-transitory computer memory that stores instructions which, when executed on the processor, provides to the at least one service provider a graphical user interface (GUI) capable of indicating to the at least one service provider data regarding the item; and
receiving through the at least one service provider accessible application an offer of at least one of the services or the goods to be associated with the at least one item, wherein the offer is suitable for acceptance by the owner using a second GUI, and wherein, upon the acceptance, the information is updated.
